(19) United States
(12) Patent Application Publication
(10) Pub. No.: US 2022/0185147 A1
(43) Pub. Date: Jun. 16, 2022

(54) POWER SUPPLY SYSTEM

(71) Applicant: HONDA MOTOR CO., LTD., Tokyo (JP)

(72) Inventors: Hirokazu OGUMA, Saitama (JP); Kenta SUZUKI, Tokyo (JP); Kenichi SHIMIZU, Tokyo (JP)

(21) Appl. No.: 17/643,171

(22) Filed: Dec. 7, 2021

(30) Foreign Application Priority Data
Dec. 14, 2020 (JP) 2020-206740

(51) Int. Cl. B60L 58/20; B60L 3/12; H02M 3/158

(52) U.S. Cl. CPC B60L 58/20; B60L 3/12; B60L 2240/547; B60L 2210/10; H02M 3/158

(57) ABSTRACT

A power supply system includes a first power circuit having a first battery; a second power circuit having a second battery which has a use voltage range relative to the closed circuit voltage which overlaps the first battery and a static voltage which Is lower than the first battery; and a management ECU, motor ECU and converter ECU which control the transfer of power between the first battery, second battery and a drive motor. The management ECU, in the case of a temperature Tbat2 of the second battery B2 being higher than a first temperature threshold T1, executes input limitation control of limiting the regeneration power supplied to the second battery B2 to within a range establishing a second regeneration power upper limit P2in_lim as the upper limit, and maxes the second regeneration power upper limit P2in_lim approach 0 as the temperature of the second battery B2 rises.

This application is based on and claims the benefit of priority from Japanese Patent Application Mo. 2020-206740, filed on 14 Dec. 2020, the content of which is incorporated herein by reference.

### BACKGROUND OF THE INVENTION

### Field of the Invention

The present invention relates to a power supply system. In more detail, it relates to a power supply system including a first electrical storage device and a second electrical storage device having use voltage ranges which overlap relative to the closed circuit voltage.

### Related Art

In recent years, development has been active in electric vehicles such as electric transport equipment equipped with a drive motor as a power generation source, and hybrid vehicles equipped with a drive motor and internal combustion engine as power generation sources. In such electric vehicles, an electrical storage device (battery, and capacitor etc.) for supplying electrical energy to the drive motor is also built in. In addition, in recent years, a vehicle equipped with a plurality of electrical storage devices having different characteristics in an electric vehicle has also been developed.

Cited Document 1 shows a power supply system for an electric vehicle including a power circuit which connects a drive unit configured from a drive motor, inverter, etc. with a first electrical storage device; a second electrical storage device connected with this power circuit via a voltage converter; and a control device which performs switching control of this voltage converter. The control device sets a target current for the passing current, which is electrical current passing through the voltage converter according to a request from the driver, and performs the switching control of the voltage converter so that the passing current becomes the target current, combines the power outputted from the first electrical storage device and the power outputted from the second electrical storage device, and then supplies this to the drive motor. During acceleration such that is not able to achieve the requested power according to the request of the driver with only the output power from the first electrical storage device, the requested power can be achieved by additionally combining the output power from the second electrical, storage device.

Patent Document 1: Japanese Unexamined Patent Application, Publication No. 2017-169311

### SUMMARY OF THE INVENTION

However, there is concern over the electrical storage device accelerating deterioration thereof when charging/discharging in a high temperature state. For this reason, with a power supply system including two electrical storage devices as described above, in the case of the temperature of the second electrical storage device which is supplementarily used according to the acceleration request from the driver being higher than a predetermined temperature, there are cases where charging/discharging of the second electrical storage device is inhibited depending on the existence of an acceleration request.

On the other hand, the power outputted from the second electrical storage device can be controlled basically by switching control of the voltage converter, in the case of connecting the first electrical storage device and the second electrical storage device having lower voltage than this first electrical storage device by the voltage converter as in the power supply system shown in Patent Document 1. However, when great power is requested in the drive motor in a state inhibiting charging/discharging of the second electrical storage device as mentioned above, there are cases where the electrical current flowing through the first electrical storage device increases, and the closed circuit voltage of the first electrical storage device becomes lower than the static voltage of the second electrical storage device. In this case, there is concern over the second electrical storage device turns to discharge irrespective of inhibiting the discharging of the second electrical storage device, unintended electrical current flows through the voltage converter from the second electrical storage device side to the first electrical storage device side, whereby deterioration of the second electrical storage device accelerates.

The present invention has an object of providing a power supply system which can suppress deterioration of electrical storage devices from unintended electrical current flowing to an electrical storage device in a high-temperature state.

A power supply system (for example, the power supply system 1 described later) according to a first aspect of the present invention includes: a high-voltage circuit (for example, the first power circuit 2 described later) having a first electrical storage device (for example, the first battery 31 described later); a low-voltage circuit (for example, the second power circuit 3 described later) having a second electrical storage device (for example, the second battery B2 described later) having a use voltage range relative to closed circuit voltage which overlaps the first electrical storage device, and a static voltage which is lower than the first, electrical storage device; a voltage converter (for example, the voltage converter 5 described later) which converts voltage between the high-voltage circuit and the low-voltage circuit; a power converter (for example, the power converter A3 described .later) which converts power between a rotary electrical machine (for example, the drive motor M described later) coupled with a drive wheel (for example, the drive wheel W described later), and the high-voltage circuit; a second electrical storage device temperature acquisition unit (for example, the second battery ECU 75 and second battery sensor unit 82 described later) for acquiring a second electrical storage device temperature (for example, the temperature Tbat2 described later), which is a temperature of the second electrical storage device; and a control device (for example, the management ECU 71, motor ECU 72 and converter ECU 73 described later) which controls transfer of power between the first electrical storage device and the second electrical storage device and the rotary electrical machine, by operating the voltage converter and the power converter, in which the control device, in a case of the second electrical storage device temperature being higher than a first temperature threshold (for example, the first temperature threshold T1 described later), executes input limitation control of controlling a regeneration power supplied to the second electrical storage device to within a range establishing a second regeneration power upper limit (for example, the second regeneration power upper limit P2in_lim described .later) as an upper limit, and makes the second regeneration power upper limit approach 0 as the second electrical, storage device temperature rises,

According to a second aspect of the present .invention, in this case, it is preferable for the power supply system to further include a first remaining amount parameter acquisition unit (for example, the first battery ECU 74 and first battery sensor unit 81 described later) for acquiring a first remaining amount parameter (for example, the charge rate of the first battery B1 described later) which increases in response to a remaining amount of the first electrical storage device, in which the control device supplies regeneration power to the first electrical storage device, in a case of a requested regeneration power relative to the rotary electrical machine exceeding the second regeneration power upper limit and the first remaining amount parameter being less than a first remaining amount threshold, during execution of the input limitation control.

According to a third aspect of the present invention, in this case, it is preferable for the control device, in a case of being during execution of the input limitation control and the first remaining amount parameter being greater than the first remaining amount threshold, to control regeneration power supplied from the rotary electrical machine to the high-voltage circuit to within a range establishing a total regeneration power upper limit as the upper limit, and make the total regeneration power upper limit approach 0 as the second electrical storage device temperature rises.

According to a fourth aspect of the present .invention, in this case, it is preferable for the control device, in a case of the second electrical storage device temperature being higher than a third temperature threshold (for example, the third temperature threshold T3 described later) decided to be higher than the first temperature threshold, to control output power of the second electrical storage device to within a range establishing a second output power upper limit (for example, the second output power upper limit P2out_lim. described later) as an upper limit, and make the second output power upper limit approach 0 as the second electrical storage device temperature rises.

According to a fifth aspect of the present invention, in this case, it is preferable for the control device, in a case of the second electrical storage device temperature being higher than the third temperature threshold, to control output power of the first electrical storage device to within a range establishing a first output power upper limit (for example, the first output power upper limit P1out_lim described later) as an upper limit, and set the first output power upper limit so that a closed circuit voltage of the first electrical storage device becomes at least a static voltage of the second electrical storage device.

According to a sixth aspect of the present invention/ in this case, it is preferable for the control device to inhibit charge and discharge of the second electrical storage device, in a case of the second electrical storage device temperature being higher than a fourth temperature threshold (for example, the fourth temperature threshold T4 described later) which is decided to be higher than the first temperature threshold.

(1) With the power supply system of the present invention, the high-voltage circuit having the first electrical storage device and the lower-voltage circuit having the second electrical storage device which has a use voltage range relative to closed circuit voltage that overlaps the first electrical storage device and has lower static voltage than the first electrical storage device are connected by the voltage converter, and the high-voltage circuit and the rotary electrical machine are connected by the power converter, in which the control device controls the transfer of power between the first and second electrical storage devices and the rotary electrical machine by operating the voltage converter and the power converter. When the use voltage ranges overlap between the first electrical storage device and second electrical storage device, the requested rotary electrical machine becomes greater, and when the electrical current flowing in the first electrical storage device increases. there are cases where the closed circuit voltage of the first electrical storage device becomes lower than the static voltage of the second electrical storage device. When the closed circuit voltage of the first, electrical storage device becomes lower than the static voltage of the second electrical storage device in this way, there are cases where power is outputted unintentionally from the second electrical storage device. In contrast, the present invention, in the case of the second electrical storage device temperature being higher than the first temperature threshold, executes input limitation control of controlling the regeneration power supplied to the second electrical storage device to within a range establishing the second regeneration power upper limit as the upper limit, and makes the .second regeneration power upper limit approach 0 as the second electrical storage device temperature rises. In other words, according to the present invention, by limiting the regeneration power to the second electrical storage device at a stage where the second electrical storage device temperature exceeds the first temperature threshold, while the second electrical storage device subsequently becomes even higher temperature, it is possible to gradually bring down the remaining amount and static voltage of the second electrical storage device and widen the voltage difference between the first electrical storage device and second electrical storage device. Consequently, according to the present invention, it is possible to suppress degradation by unintended discharge of the second electrical storage device in the high temperature state. In addition/according to the present invention/by limiting charging to the second electrical storage device at a stage where the second electrical storage device temperature exceeded the first, temperature threshold, it is possible to suppress degradation of the second electrical storage device from charging being performed in the high temperature state. In addition, according to the present invention, by making the second regeneration power upper limit approach 0 as the second electrical storage device temperature rises, it is possible to lower the remaining amount of the second electrical storage device without giving an uncomfortable feeling to the driver.

(2) In the present invention, the control device supplies regeneration power to the first electrical storage device, in the case of the requested regeneration power to the rotary electrical machine exceeding the second regeneration power upper limit and the first remaining amount parameter being less than the first remaining amount threshold, during execution of the input limitation control. Consequently, according to the present invention, since it is possible to supply the regeneration power which could not be supplied to the second electrical storage device to the first electrical storage device, it is possible to suppress degradation of the second electrical storage device, without wasting the regeneration power.

(3) In the present invention, the control devices controls the regeneration power supplied from the rotary electrical machine to the high-voltage circuit to within a range establishing the total regeneration power upper limit as the upper limit, in the case of being during execution of the input limitation control and the first remaining amount parameter being larger than the first remaining amount threshold, and makes the total regeneration power upper limit approach 0 as the second electrical storage device temperature rises. Consequently, according to the present invention, since it is possible to prevent the first electrical storage device from reaching overcharge while limiting the regeneration power to the second electrical storage device, it is possible to suppress degradation of both the first electrical storage device and the second electrical storage device. In addition, in the present invention, it is possible to prevent the regenerative braking from suddenly decreasing, by making the total regeneration power upper limit approach 0 as the second electrical storage device temperature rises.

(4) In the present invention, the control device controls the output power of the second electrical storage device to within a range establishing the second output power upper limit as the upper .limit, In the case of the second electrical storage device temperature being higher than a third temperature threshold which is decided to be higher than the first temperature threshold, and makes the second output power upper limit approach 0 as the second electrical storage device temperature rises. In other words, with the present invention, by deciding the third temperature threshold at which starting limitation of the output power of the second electrical storage device to be higher than the first temperature threshold at which starting limitation of regeneration power to the second electrical storage device, while the second electrical storage device temperature is between the first temperature threshold and third temperature threshold, since it is possible to permit discharge of the second electrical storage device while limiting the regeneration power to the second electrical storage device, it is possible to further widen the voltage difference between the first electrical storage device and second electrical storage device after the second electrical storage device temperature has exceeded the first temperature threshold. Consequently, according to the present invention, it is possible to further suppress degradation by unintended discharge of the second electrical storage device in a high temperature state. In addition, according to the present invention, by making the second output power upper limit approach 0 as the second electrical storage device temperature rises, it is possible to cause the remaining amount of the second electrical storage device to decline without giving an uncomfortable feeling to the driver.

(5) In the present, invention, the control device controls the output of the first electrical storage device to within a range establishing the first output power upper limit as the upper limit in the case of the second electrical storage device temperature being higher than the third temperature threshold, and sets the first output power upper limit so that the closed circuit, voltage of the first electrical storage device becomes at least the static voltage of the second electrical storage device. Consequently, according to the present, invention, even in a case of the static voltage of the second electrical storage device not sufficiently declining even when executing the input limitation control, since it is possible to limit the output power of the first electrical storage device so that, the closed circuit voltage of the first electrical storage device will not fall below the static voltage of the second electrical storage device, it is possible to more reliably suppress unintended discharge from the second electrical storage device, and thus possible to suppress degradation of the second electrical storage device.

(6) In the present invention, the control device inhibits charging/discharging of the second electrical storage device, in the case of the second electrical storage device temperature being higher than the fourth temperature threshold which is decided to be higher than the first temperature threshold. Consequently, with the present invention, by limiting the regeneration power to the second electrical storage device at a stage where the second electrical storage device temperature exceeded the first temperature threshold which is decided to be .lower than the fourth temperature threshold at which inhibiting charge and discharge of the second electrical storage device, while the second electrical storage device temperature subsequently reaches the fourth temperature threshold, since it is possible to lower the remaining amount and static voltage of the second electrical storage device, it is possible to secure sufficient voltage difference between the first electrical storage device and the second electrical storage device, at the moment when the second electrical storage device temperature reached the fourth temperature threshold. Consequently, according to the present invention, it is possible to more reliably suppress unintended discharge from the second electrical storage device in a state in which the second p temperature is higher than the fourth temperature threshold.

### BRIEF DESCRIPTION OF THE DRAWINGS

FIG. 1 is a view showing the configuration of an electric vehicle equipped with a power supply system according to an embodiment of the present invention;

FIG. 2 provides graphs comparing use voltage ranges of a first battery and a second battery;

FIG. 3 is a view showing an example of the circuit configuration of a voltage converter;

FIG. 4 is a flowchart showing a specific sequence of power management processing during powered running of a drive motor;

FIG. 5 is a graph showing an example of an opening rate calculation map of the second buttery;

FIG. 6 is a flowchart showing a sequence of calculating a first output power upper limit for the first battery;

FIG. 7 provides time charts showing changes in voltage of the first battery/voltage of the second battery and charge rate of the second battery, when accelerating in a state in which the temperature of the second battery is greater than a third temperature threshold; and

FIG. 8 is a flowchart showing a specific sequence of power management processing during regeneration by the drive motor.

### DETAILED DESCRIPTION OF THE INVENTION

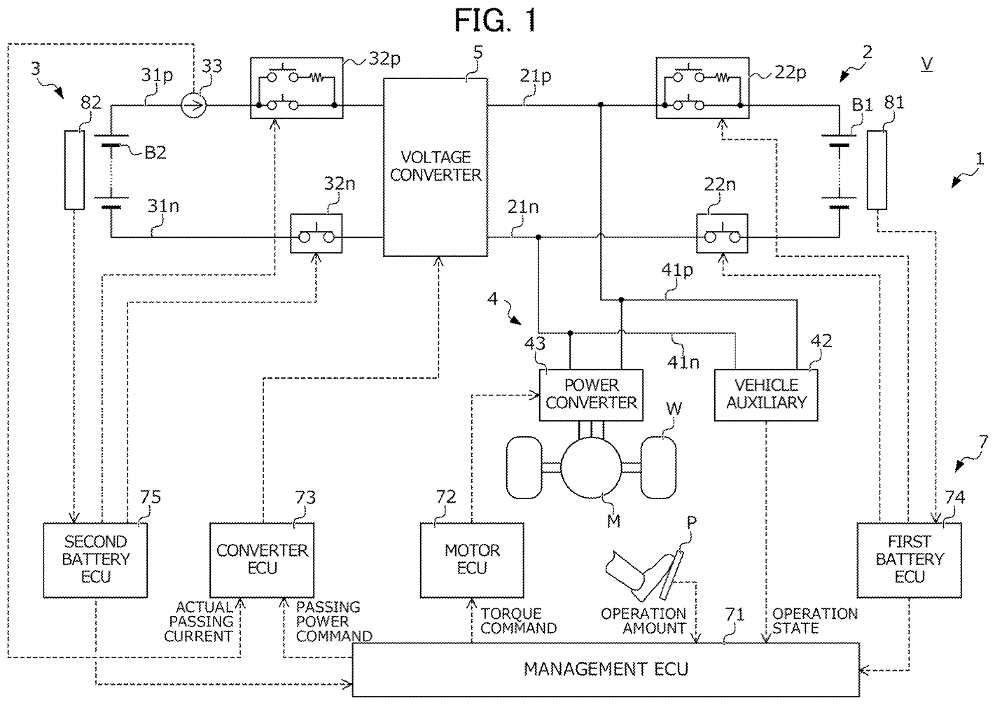

Hereinafter, an embodiment of the present invention will be explained while referencing the drawings. FIG. 1 is a view showing the configuration of an electric vehicle V (hereinafter simply referred to as “vehicle”) equipped with a power supply system i according to the present embodiment.

The vehicle V includes drive wheels W, a drive motor M serving as a rotary electrical machine coupled to these drive wheels W; and a power supply system 1 which performs transferring of power between this drive motor M and a first battery B1 and second battery B2 described later. It should be noted that, the present embodiment explains an example in which the vehicle V accelerates and decelerates by the motive power generated mainly by the drive motor M; however, the present invention is not to be limited thereto. The vehicle V may be established as a so-called hybrid vehicle equipped with the drive motor M and an engine as the motive power generation source.

The drive motor M is coupled to the drive wheels W via a power transmission system which is not illustrated. The drive torque generated by the drive motor M by supplying three-phase electricity to the drive motor M from the power supply system 1 is transferred to the drive wheels W via the power transmission system which is not illustrated, causing the drive wheels W to rotate to make the vehicle V travel. In addition, the drive motor M exhibits a function of a generator during deceleration of the vehicle V, generates regenerative electric power, and gives the regenerative braking torque to the drive wheels W responsive to the magnitude of this regenerative electric power. The regenerative electric power generated by the drive motor M is charged to the batteries B1, B2 of the power supply system 1 as appropriate.

The power supply system 1 includes: a first power circuit 2 having the first battery B1 serving as a first electrical storage device; a second power circuit. 3 having the second battery B2 serving as a second electrical storage device; a voltage converter 5 connecting this first power circuit 2 and second power circuit 3; a load circuit 4 having various electrical loads including the drive motor M; and an electronic control unit group 7 which operates these power circuits 2, 3, A and voltage converter 5. The electronic control unit group 7 includes a management ECU 71, motor ECU 72, converter ECU 73, first battery ECU 74 and second battery ECU 75, which are each computers.

The first battery B1 is a secondary battery capable of both discharging which converts chemical energy into electrical energy, and charging which converts the electrical energy into chemical energy. Hereinafter, a case is explained using a so-called lithium-ion buttery which performs charging/discharging by the lithium ions migrating between electrodes as this first battery B1; however, the present invention is not limited thereto. A capacitor may be used as the first battery B1.

A first battery sensor unit 81 for estimating the internal state of the first battery B1 is provided to the first battery B1. The first battery sensor unit 82 detects a physical quantity required in order to acquire the charge rate of the first battery 31 (value expressing the charged amount of the battery by percentage; increases according to the remaining amount of the first battery B1), the temperature, etc. in the first battery ECU 74, and is configured by a plurality of sensors which send signals according to the detection value to the first battery ECU 74. Here specifically, the first battery sensor unit 81 is configured by a voltage sensor that detects the terminal voltage of the first battery B1, a current sensor that detects the electrical current flowing in the first battery B1, a temperature sensor that detects the temperature of the first battery B1, etc.

The second battery B2 is a secondary battery capable of both discharging that converts chemical energy into electrical energy, and charging that converts electrical energy into chemical energy. Hereinafter, a case is explained using a so-called lithium-ion battery which performs charging/discharging by the lithium ions migrating between electrodes as this second battery B2; however, the present invention is not limited thereto. The second battery 32 may employ capacitors, for example.

A second battery sensor unit 82 for estimating the internal state of the second battery B2 is provided to the second battery B2. The second battery sensor unit 82 detects a physical quantity required for acquiring the charge rate, temperature, etc. of the second battery B2 in the second battery ECU 75, and is configured by a plurality of sensors which send signals according to the detection value to the second battery ECU 75. More specifically, the second battery sensor unit 82 is configured by a voltage sensor that detects terminal voltage of the second battery B2, a current sensor that detects the electrical current flowing in the second battery B2, a temperature sensor that detects the temperature of the second battery B2, etc.

Herein, the characteristics of the first, battery B1 and the characteristics of the second battery B2 are compared. The first battery B1 has lower output weight density and higher energy weight density than the second battery B2. In addition, the first battery B1 has larger capacity than the second battery B2. in other words, the first battery B1 is superior to the second battery B2 in the point of energy weight density. It should be noted that energy weight density is the electrical energy per unit weight (Wh/kg), and the output weight density is the power per unit weight (W/kg). Therefore, the first battery 31 which excels in the energy weight density is a capacitive battery with the main object of high capacity and the second battery B2 which excels in output weight density is an output-type battery with the main object of high output. For this reason, the power supply system 1 uses the first battery B1 as the main power source, and uses the second battery B2 as an auxiliary power source which supplements the first battery B1.

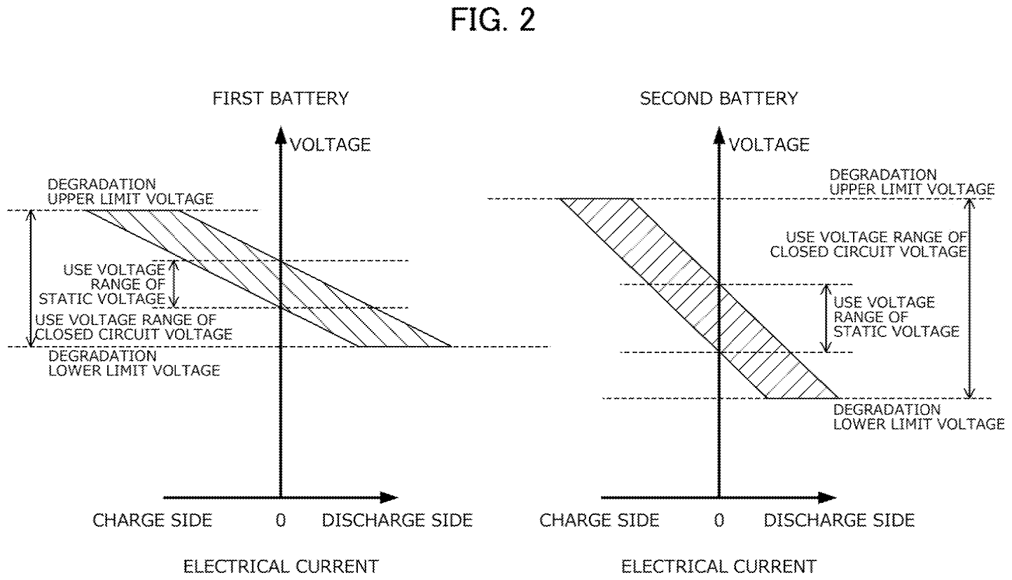

FIG. 2 provides graphs comparing the use voltage ranges of the first battery B1 and second battery B2 in the power supply system 1. In FIG. 2, the left side is a graph showing the use voltage range of the first, battery B1, and the right side is a graph showing the use voltage range of the second battery B2.

In FIG. 2, the horizontal axis showing the electrical current, flowing in the battery, and the vertical axis shows the voltage of the battery.

As shown in FIG. 2, the static voltage of the batteries B1, B2 (i.e. voltage in a state in which electrical current is not flowing to the battery, referred to as open circuit voltage) has a characteristic of rising with higher charge rate. Therefore, the upper limit for the use voltage ranges relative to static voltage of the batteries B1, B2 are static voltages of each when the charge rate is the maximum value (e.g., 100%), and the lower limit is the static voltage of each when the charge rate is the minimum value (e.g., 0%). As shown in FIG. 2, the upper limit for the use voltage range relative to static voltage of the second battery B2 is lower than the upper limit for the use voltage range relative to the static voltage of the first battery B1. For this reason, the static voltage of the second battery B2 during travel of the vehicle V is basically maintained lower than the static voltage of the first battery B1.

As shown in FIG. 2, there is a characteristic in which the closed circuit voltage of the batteries B1, B2 (i.e. voltage in a state in which electrical current is flowing to the battery) also rises with higher charge rate. In addition, since Internal resistance exists in the batteries B1, B2, the closed circuit voltage thereof has a characteristic of lowering from the static voltage as the discharge current increases, and rising from the static voltage as the charge current increases. Therefore, the upper limit of the use voltage range for the closed circuit voltage of the batteries B1, B2 is higher than the upper limit o.f the use voltage range for each static voltage, and the lower limit is lower than the lower limit of the use voltage range relative to each static voltage. In other words, the use voltage range for the closed circuit voltage of the batteries B1, B2 includes the use voltage range for each static voltage. As shown in FIG. 2, the use voltage range for the closed circuit voltage of the first battery B1 overlaps the use voltage range for the closed circuit voltage of the second battery B2.

In addition, since the degradation of the batteries 31, 32 is promoted when the charge current increases excessively, the upper limit of the use voltage range for the closed circuit voltage of these batteries B1, B2 is set so that these batteries B1, B2 will not degrade, based on the states of these batteries B1, B2. Hereinafter, the upper limit of the use range of the closed circuit voltage of these batteries B1, B2 is also referred to as degradation upper limit voltage.

In addition, when the discharge current increases excessively, since the degradation of the batteries B1, B2 is promoted, the lower limit of the use voltage range for the closed circuit voltage of these batteries B1, B2 is set so that these batteries B1, B2 will not degrade, based on the states of these batteries B1, B2. Hereinafter, the lower limit of the use range of the closed circuit voltage of these batteries B1, B2 is also referred to as degradation lower limit voltage.

Referring back to FIG. 1, the first output circuit 2 includes: the first battery B1, first power lines 21p, 21n which connect both positive and negative poles of this first battery B1 and the positive terminal and negative terminal on the high-voltage side of the voltage converter 5, and a positive contactor 22p and negative contactor 22n provided to these first power lines 21p, 21n.

The contactors 22p, 22n are normal open type which opens in a state in which a command signal from outside is not being inputted and breaks conduction between both electrodes of the first battery B1 and the first power lines 21p, 21n; and closes in a state in which a command signal is being inputted and connects the first battery 81 and first power lines 21p, 21n. These contactors 22p, 22n open/close according to a command signal transmitted from the first battery ECU 74. It should be noted that the positive contactor 22p is a pre-charge contactor having a pre-charge resistance for mitigating the inrush current to a plurality of smoothing capacitors provided to the first power circuit 2, load circuit 4, etc.

The second power circuit 3 includes: the second battery B2, second power lines 31p, 31n which connect both positive and negative poles of this second battery B2 and the positive terminal and negative terminal on the low-voltage side of the voltage converter 5, a positive contactor 32p and negative contactor 32n provided to these second power lines 31p, 31n, and a current sensor 33 provided to the second power line 31p.

The contactors 32p, 32n are normal-open type which open in a state in which a command signal from outside is not being inputted to break conduction between both electrodes of the second battery B2 and the second power lines 31p, 31n, and close in a state in which a command signal is being inputted to connect between the second battery 32 and the second power lines 31p, 31n. These contactors 32p, 32n open/close in response to a command signal transmitted from the second battery ECU 75. it should be noted that the cathode contactor 32p is a pre-charge contactor having a pre-charge resistance for mitigating the inrush current to a plurality of smoothing capacitors provided to the first power circuit 2, load circuit 4, etc.

The electric current sensor 33 sends a detection signal according to a value of passing current, which is the electrical current flowing through the second power line 31p, i.e. electrical current flowing through the voltage converter 5, to the converter ECU 73. It should be noted that, in the present embodiment/ the direction of passing current defines from the second power circuit 3 side to the first power circuit 2 side as positive/and defines from the first power circuit. 2 side to the second power circuit 3 side as negative.

The load circuit 4 includes: a vehicle accessory 42, output converter 43 to which the drive motor M is connected, and load power lines 41p, 41n which connect this vehicle accessory 42 and output converter 43 with the first power circuit 2.

The vehicle accessory 42 is configured by a plurality of electrical loads such as a battery heater, air compressor, DC/DC converter, and onboard charger. The vehicle accessory 42 is connected to the first power lines 21p, 21n of the first power circuit 2 by the load power lines 41p, 41n, and operates by consuming the electric power of the first power lines 21p, 21n. The information related to the operating state of various electrical loads constituting the vehicle accessory 42 is sent to the management ECU 71, for example.

The power converter 43 is connected to the first power lines 21p, 21n so as to be parallel with the vehicle accessory 42, by the .load power lines 41p, 41n. The power converter 43 converts the electric power between the first power lines 21p, 21n and the drive motor M. The power converter 43, for example, is a PWM inverter according to pulse width modulation, provided with a bridge circuit configured by a bridge connecting a plurality oi switching elements (e.g., IGBT), and is equipped with a function of converting between DC power and AC power. The power converter 43 is connected to the first power lines 21p, 21n on the DC I/O side thereof, and is connected to each coil of the U phase, V phase and W phase of the drive motor M at the AC I/O side thereof. The power converter 43 converts the AC power of the first power lines 21p, 21n into three-phase AC power and supplies to the drive motor M, by ON/OFF driving the switching elements of each phase in accordance with a gate drive signal generated at a predetermined timing from a gate drive circuit (not shown) of the motor ECU 72, and thus generates drive torque in the drive motor M, and converts the three-phase AC power supplied from the drive motor M into DC power and supplies to the first power lines 21p, 21n, and thus generates regenerative braking torque in the drive motor M.

The voltage converter 5 connects the first power circuit 2 and second power circuit 3, and converts the voltage between both circuits 2, 3. A known boost circuit is used in this voltage converter 5.

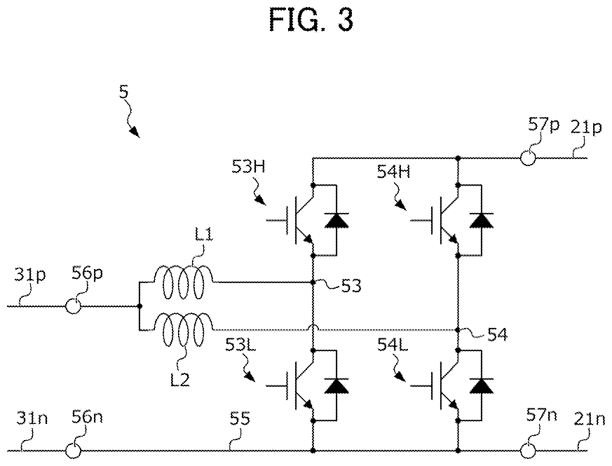

FIG. 3 is a view showing an example of the circuit configuration of the voltage converter 5. The voltage converter 5 connects the first power lines 21p, 21n to which the first battery B1 is connected, and the second power lines 31p, 31n to which the second battery B2 is connected, and converts the voltage between these first power lines 21p, 21n and second power lines 31p, 31n. The voltage converter 5 is a full-bridge DC/DC converter configured by combining a first, reactor L1, a second reactor L2, a first high-arm element 53H, a first low-arm element 53L, a second high-arm element 54H, a second low-arm element 54L, a negative bus 55, low-voltage side terminals 56p, 56n, high-voltage side terminals 57p, 57n, and a smoothing capacitor (not shown).

The low-voltage side terminals 56p, 56n are connected to the second power lines 31p, 31n, and the high-voltage side terminals 57p, 57n are connected to the first power lines 21p, 21n. The negative bus 55 is wiring connecting the low-voltage side terminal 56n and high-voltage side terminal 57n.

The first reactor L1 has one end side thereof connected to the low-voltage side terminal 56p, and the other end side connected to a connector node 53 between the first high-arm element 53H and first low-arm element 53L. The first high-arm element 53H and first low-arm element 53L each include a well-known power switching element such as IGBT or MOSFET, and a freewheeling diode connected to this power switching element. This high-arm element 53H and low-arm element 53L are connected in this order in series between the high-voltage side terminal 57p and negative bus 55.

A collector of the power switching element of the first high-arm element 53H is connected to the high-voltage side terminal 57p, and the emitter thereof is connected to the collector of the first low-arm element 53L. The emitter of the power switching element of the first low-arm element 53L is connected to the negative bus 55. The forward direction of the freewheeling diode provided to the first high-arm element 53H is a direction from the first reactor L1 towards the high-voltage side terminal 57p. in addition/ the forward direction of the freewheeling diode provided to the first Iow-arm element 53L is a direction from the negative bus 55 towards the first reactor L1.

The second reactor L2 has one end side connected to the low-voltage side terminal 56p, and the other end side connected to a connection node 54 between the second high-arm element 54H and second low-arm element 54L. The second high-arm element 5411 and second low-arm element 54L each include a well-known power switching element such as IGBT or MOSFET, and a freewheeling diode connected to this power switching element. This high-arm element 54H and low-arm element 54L are connected in this order in series between the high-voltage side terminal 57p and negative bus 55.

A collector of the power switching element of the second high-arm element 54H is connected to the high-voltage side terminal 57p, and the emitter thereof is connected to the collector of the second low-arm element S4L. The emitter of the power switching element of the second low-arm element 54L is connected to the negative bus 55. The forward direction of the freewheeling diode provided to the second high-arm element 54H is a direction from the second reactor L2 towards the high-voltage side terminal 57p. in addition, the forward direction of the freewheeling diode provided to the second low-arm element 54L is a direction from the negative bus 55 towards the second reactor L2.

The voltage converter 5 converts the voltage between the first power lines 21p, 21n and the second power lines 31p, 31n, by alternately driving ON/OFF the first high-arm element 53H and second low-arm element 54L, and the first low-arm element 53L and second high-arm element 54, in accordance with the gate drive signal generated at a predetermined timing from a gate drive circuit (not shown; of the converter ECU 73.

As explained by referencing FIG. 2, the static voltage of the second battery B2 during travel of the vehicle V is basically maintained lower than the static voltage of the first battery 31. Therefore, tie voltage of the first power lines 21p, 21n is basically higher than the voltage of the second power lines 31p, 31n. Therefore, the converter ECU 73, in a case of driving the drive motor M using both the power outputted from the first battery B1 and the power outputted from the second battery B2, operates the voltage converter 5 so that a boost function is exhibited in the voltage converter 5. Boost function refers to a function of stepping up the power of the second power lines 31p, 31n to which the low-voltage side terminals 56p, 56n are connected/and outputting to the first power lines 21p, 21n to which the high-voltage side terminals 57p, 57n are connected/whereby positive passing current flows from the second power lines 31p, 31n side to the first power lines 21p, 21n side. In addition, in the case of suppressing discharge of the second battery B2, and driving the drive motor M with only the power outputted from the first battery B1, the converter ECU 73 is configured so as to turn OFF the voltage converter 5, and make so that electrical current does not flow from the first power lines 21p/21n to the second power lines 31p, 31n. However, in this case, when the voltage of the second power lines 31p, 31n becomes higher than the voltage of the first power lines 21p, 21n, the second battery B2 turns to discharge, and positive passing current of a magnitude according to the voltage difference may flow from the second power lines 31p, 31n to the first power lines 21p, 2in via the freewheeling diodes of the high-arm elements 53H, 54H.

In addition, in the case of charging the first battery B1 or second battery B2 by the regenerative electric power outputted from the drive motor M to the first power lines 21p, 21n during deceleration, the converter ECU 73 operates the voltage converter 5 so as to exhibit a step-down function in the voltage converter 5. Step-down function refers to a function of stepping down the electric power in the first power lines 21p, 21n to which the high-voltage side terminals 57p, 57n are connected, and outputting to the second power lines 31p, 31n to which the low-voltage side terminals 56p, 56n are connected, whereby negative passing current flows from the first power lines 21p, 21n side to the second power lines 31p, 31n side.

Referring back to RIG. 1, the first battery ECU 74 is a computer mainly handling state monitoring of the first battery B1 and the ON/OFF operation of the contactors 22p, 22n of the first power circuit 2. The first battery ECU 74, based on a known algorithm using the detection value sent from the first battery sensor unit 91, calculates various parameters representing the internal state of the first battery B1, more specifically, the temperature of the first battery B1, internal resistance of the first battery B1, static voltage of the first battery B1, open-circuit voltage of the first battery 31, degradation upper limit voltage of the first battery 31, degradation lower limit voltage of the first battery 31, charge rate of the first battery B1, etc. The information related to the parameters representing the internal state of the first battery B1 acquired in the first battery ECU 74 is sent to the management ECU 71, for example.

The second battery ECU 75 is a computer mainly handling state monitoring of the second battery B2 and open/close operation of the contactors 32p, 32n of the second power circuit 3. The second battery ECU 75, based on a known algorithm using the detection value sent from the second battery sensor unit 32, calculates various parameters representing the internal state of the second battery 52, more specifically, the temperature of the second battery 82, internal resistance of the second battery B2, static voltage of the second battery B2, closed-circuit voltage of the second battery B2, charge rate of the second battery B2, etc. The information related to the parameters representing the internal state of the second battery B2 acquired in the second battery ECU 75 is sent to the management ECU 71, for example.

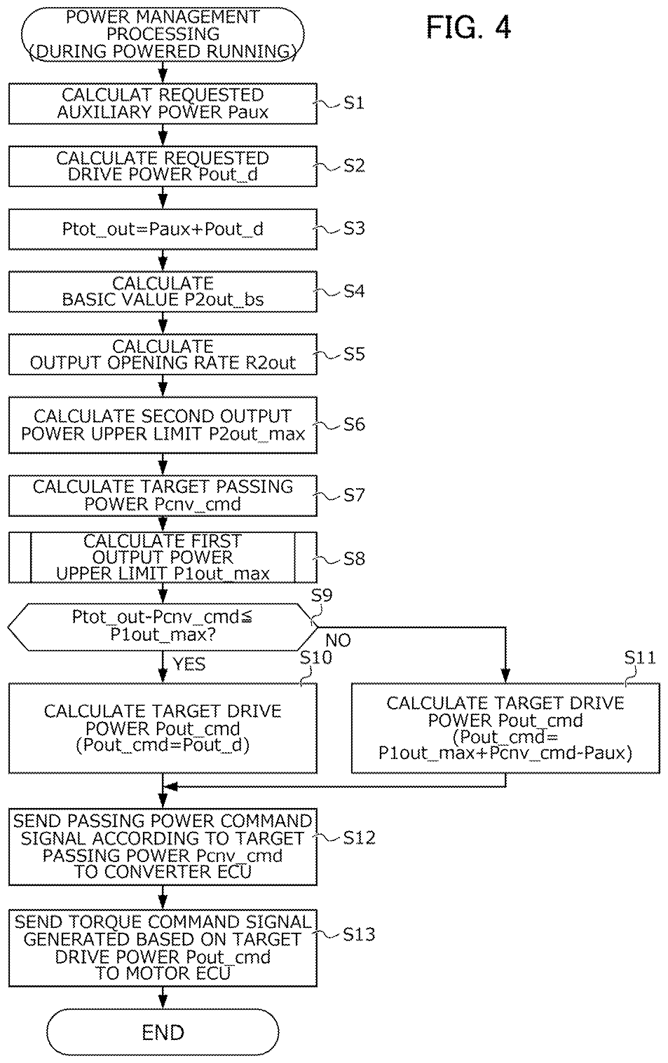

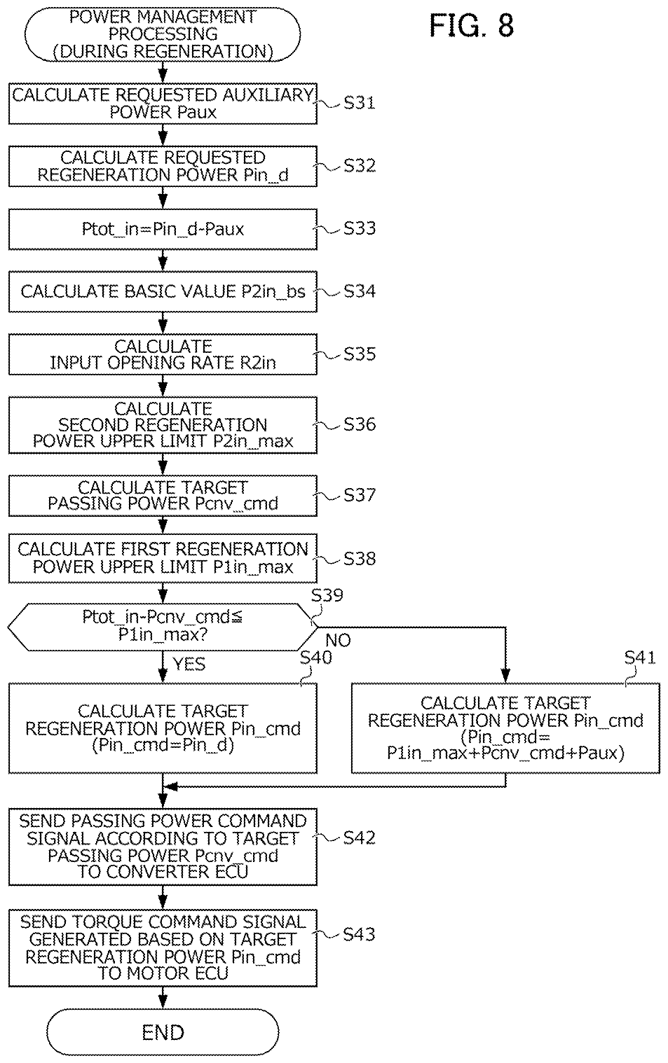

The management ECU 71 is a computer managing mainly the flow of electric power in the overall power supply system 1. The management ECU 71 generates a torque command signal corresponding to a command related to the drive torque or regenerative braking torque generated by the drive motor M, and a passing power command signal corresponding to a command related to electric power passing through the voltage converter 5, by executing the power management processing explained by referencing FIGS. 4 and 8 later.

The motor ECU 72 is a computer mainly managing the flow of electric power from the first power circuit 2 to the electric motor M. Based on the torque command signal sent from the management ECU 71, the motor ECU 72 operates the power converter 43 so that the drive torque or regenerative braking torque according to this command generates in the drive motor M.

The converter ECU 73 is a computer which manages the flow of passing power, which is electric power passing through the voltage converter 5 mainly. The. converter ECU 73 operates the voltage converter 5 so that passing power according to the command passes through the voltage converter 5, in response to the passing power command signal sent from the management ECU 71. More specifically, the converter ECU 73, based on the passing power command signal, calculates the target current, which is the target relative to the passing current of the voltage converter 5, and operates the voltage converter 5 following a known feedback control algorithm, so that passing current (hereinafter referred to as “actual passing current”) detected by the current sensor 33 becomes the target current.

FIG. 4 is a flowchart showing the specific sequence of the power management processing during powered running of the drive motor M. This power management processing (during powered running) is repeatedly executed at a predetermined period in the management ECU 71 during powered running of the drive motor M.

First, in Step S1, the management ECU 71 calculates the requested auxiliary power Paux, which is the power requested in the vehicle auxiliary 42, and then advances to Step S2. The management ECU 71 calculates the requested auxiliary power Paux, based on the information related to the operating state of various electrical loads sent from the vehicle auxiliary 42.

Next, in Step S2, the management ECU 71 calculates the requested driving power Pout_d corresponding to a request, for the power supplied from the first power circuit 2 to the drive motor M via the power converter 43 during powered running of the drive motor M, and then advances to the Step S3. The management ECU 71 calculates the requested drive power Pout_d by calculating the requested drive torque corresponding to the request for drive torque generated by the drive motor M based on the operation amount of the pedals P such as the accelerator pedal and brake pedal (refer to FIG. 1) by the driver, and converting this requested drive torque into power.

Next, in Step S3, the management ECU 71 calculates the total requested output power Ptot_out corresponding to the request for the sum of output power from the first battery B1 and second battery 82, by summing the requested auxiliary power Paux calculated in Step S1 and the requested drive power Pout_d calculated in Step S2, and then advances to Step S4.

Next, in Step S4, the management ECU 71 calculates a basic value P2out_bs for the upper limit of the power outputted from the second battery B2 (i.e. second output power upper limit P2out_max described later), and then advances to Step S5. More specifically, the management ECU 71 calculates the basic value P2out_bs, by searching a map (not shown) based on information related to parameters representing the internal state of the second battery B2 sent from the second battery ECU 75.

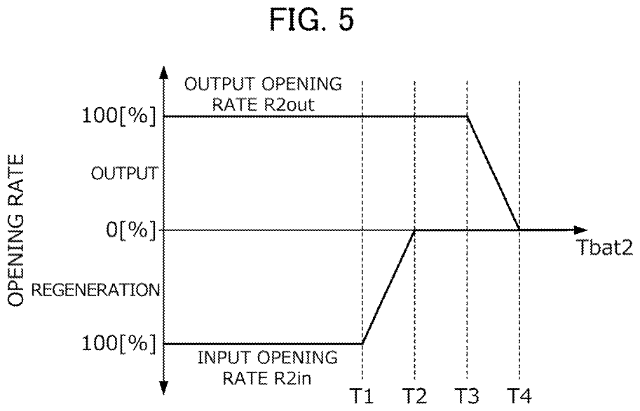

Next, in step S5, the management ECU 71 calculates the output opening rate R2out for the upper limit of the power outputted from the second battery B2 (i.e. second output power upper limit P2out_max described later), and then advances to Step S6. More specifically, the management ECU 71 calculates a temperature Tbat2 of the second battery B2 based on information related to the internal state of the second battery B2 sent from the second battery ECU 75, and calculates the output opening rate R2out by searching the opening rate calculation map illustrated in FIG. 5 based on this temperature Tbat2.

As shown in FIG. 5, the management ECU 71, in the case of the battery Tbat2 of the second battery B2 being no higher than a third temperature threshold, sets the output opening rate R2out of the second battery B2 to 100%, and in the case of the temperature Tbat2 of the second battery B2 being higher than a fourth temperature threshold T4 set to be higher than the third temperature threshold T3, sets the output opening rate R2out of the second battery B2 to 0%. In other words, the management ECU 71, in the case of the temperature Tbat2 of the second battery B2 being higher than a fourth temperature threshold T4, prevents degradation from the second battery B2 in a high temperature state discharging, and thus sets the upper limit of the power outputted from the second battery B2 as 0, and inhibits discharge of the second battery B2.

In addition, the management ECU 71, in the case of the temperature Tbat2 of the second battery B2 being higher than the third temperature threshold T3 and no more than the fourth temperature threshold T4, makes the output opening rate T2out of the second battery B2 to be smaller as the temperature Tbat2 rises. In other words, the management ECU 71, in the case of the temperature Tbat2 of the second battery B2 being higher than the third temperature threshold T3, makes the second output power upper limit P2out_max described later approach 0 as the temperature Tbat2 rises. In other words, the management ECU 71, in the case of the temperature Tbat2 of the second battery B2 being higher than the third temperature threshold T3, gradually limits discharging of the second battery B2 by making the second output power upper limit P2out__max approach 0 as the temperature Tbat2 rises, in order to prevent degradation by the second battery B2 in the high temperature state discharging. In addition, the management ECU 71, in the case of the temperature Tbat2 of the second battery B2 being higher than the fourth temperature threshold 74, inhibits discharge of the second battery B2, by setting the second output power upper limit P2out_max to 0.

Referring back to FIG. 4, in Step S6, the management ECO 71 calculates the second output power upper limit P2out_max corresponding to the upper limit for power outputted from the second battery B2, and then advances to Step S7. More specifically, the management ECU 71 calculates the second output power upper limit P2out_max, by multiplying the output opening rate R2out calculated in Step S5, by the basic value P2out_bs calculated in Step S4.

In Step S7, the management ECU 71 calculates, within a range of no more than the second output power upper limit P2out_max, the target passing power Pcnv_cmd corresponding to the target for the passing power (i.e. output power of the second battery B2) flowing through the voltage converter 5 from the second power circuit 3 side to the first power circuit 2 side during powered running of the drive motor M, and then advances to Step S8. More specifically, the management ECU 71 calculates the target passing power Pcnv_cmd so as not to exceed the second output power upper limit P2out_max, based on information related to parameters representing the internal state of the first battery B1 sent from the first battery ECU 74, information related to parameters representing the internal state of the second battery B2 sent from the second battery ECU 75, requested drive power Pout_d, etc. The output power of the second battery B2 is thereby controlled to the target passing power Pcnv_crnd decided within a range establishing the second output power upper limit P2out_max as the upper limit and 0 as the lower limit.

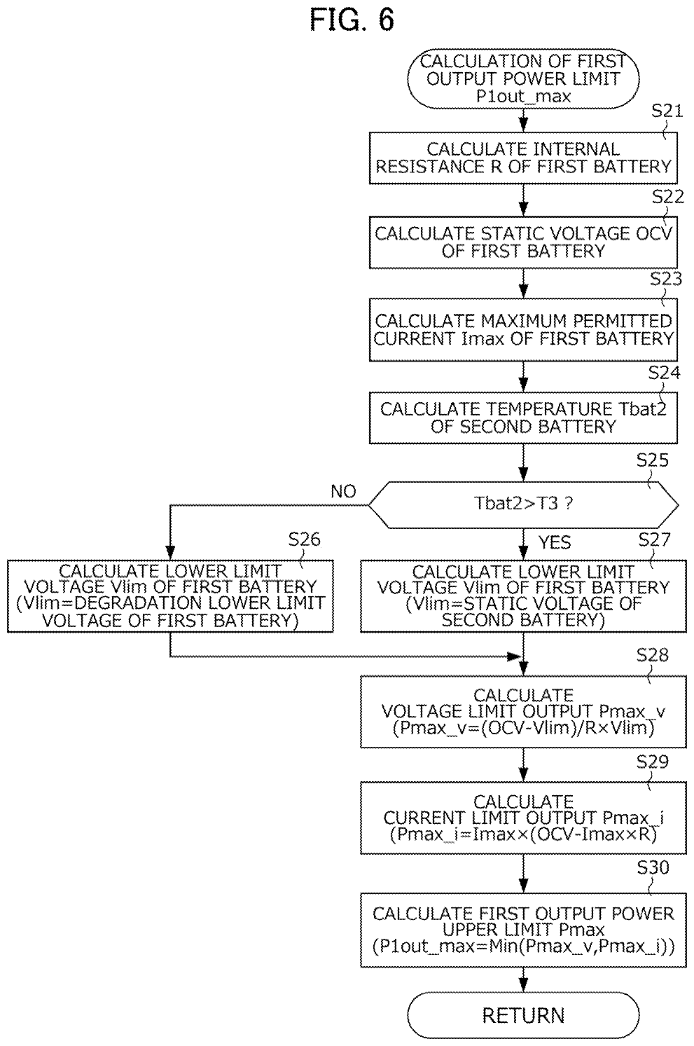

Next, in Step S8, the management ECU 71 calculates the first output power upper limit Plout_max, which is the upper limit for the power outputted from the first battery B1, and then advances to Step S9. It should be noted that a specific sequence of calculating this first output power upper limit Plout_max will be explained by referencing FIG. 6 later.

Next, in Step S9, the management ECU 71 determines whether the power obtained by subtracting the target passing power Pcnv_cmd from the total requested output power Ptot_out is no more than the first output power upper limit Plout_max. Herein, power obtained by subtracting the target passing power Pcnv_cmd from the total requested output power Ptot_out corresponds to the request for output power of the first battery B1. Therefore, the determination in Step S9 corresponds to determining whether the output power of the first battery B1 can satisfy the request from the driver without exceeding the first output power upper limit Plout_max. The management ECU 71 advances to Step S10 in the case of the determination result in Step S9 being YES, and advances to Step S11 in the case of being NO.

In Step S10, the management ECU 71 calculates the target drive power Pout_crnd corresponding to the target for the power supplied from the first, power circuit 2 to the drive motor M vie the power converter 43, and then advances to Step S12. In the case of the determination result in Step S9 being YES as mentioned above, since the output power of the first battery B1 can satisfy the request of the driver without exceeding the first output power upper limit Plout_max, the management ECU 71 sets the requested drive power Pout_d calculated in Step S2 as the target drive power Pout_cmd.

In Step S1, the management ECU 71 calculates the target drive power Pout_cmd, and then advances to Step S12. In the case of the determination result in Step S9 being NO as mentioned above, if trying to satisfy the request of the driver, since the output power of the first battery B1 exceeds the first output power upper limit Plout_max, the management ECU 71 calculates the target drive power Pout_cmd so that the output power of the first battery B1 does not exceed the first output power upper limit Plout_max. More specifically, the management ECU 71, for example, calculates the target drive power Pout_cmd by subtracting the requested auxiliary power Paux from the sum of the first output power upper limit Plout_max and the target passing power Pcnv_cmd. The output power of the first, battery Bi thereby becomes the first output power upper limit Plout_max, and will not exceed this first output, power upper limit Plout_max.

Next, in Step S12, the management ECU 71 generates the passing power command signal according to the target passing power Pcnv_cmd calculated in Step S7, sends this to the converter ECU 73, and then advances to Step 513. The converter ECU 73 operates the voltage converter 5 based on this passing power command signal. The power according to the target passing power Pcnv_cmd is thereby outputted from the second battery B2 to the first power circuit 2.

Next, in Step S13, the management ECU 71 generates a torque command signal based on the target drive power Pout_cmd, sends this to the motor ECU 72, and then ends the power management processing (during powered running). More specifically, the management ECU 71 calculates the target drive torque by converting the target drive power Pout_cmd into torque, and generates a torque command signal according to this target drive torque. The motor ECU 72 operates the power converter 43 based on this torque command signal. The power according to the target drive power Pout_cmd is thereby outputted from the first power circuit 2 to the drive motor M. In this way, with the management ECU 71, by generating the torque command signal based on the target drive power Pout_cmd calculated through the processing of Step S10 or S11, the power outputted from the first battery B1 will not exceed the first output power upper limit Plout_max.

FIG. 6 is a flowchart showing a sequence of calculating the first output power upper limit Plout_max for the first battery B1 by the management ECU 71.

First, in Step S21, the management ECU 71 calculates the internal resistance R of the first battery B1 based on information related to the internal state of the first battery B1 sent from the first battery ECU 74, and then advances to Step S22.

In Step S22, the management ECU 71 calculates the static voltage OCV of the first battery B1 based on information related to the internal state of the first battery B1 sent from the first battery ECU 74, and then advances to Step S23.

In Step S23, the management ECU 71 calculates a maximum permitted current Imax of the first battery B1, based on information related to the internal state of the first battery B1 sent from the first battery ECU 74, and then advances to Step S24. This maximum permitted current Imax is the maximum value for the permitted range of electrical current flowing in the first battery B1. In other words, when the electrical current flowing in the first battery B1 exceeds the maximum permitted current Imax, there is concern over the first battery B1 degrading.

In Step S24, the management ECU 71 calculates the temperature T of the second battery B2 based on information related to the internal state of. the second battery B2 sent from the second battery ECU 75, and then advances to Step S25. Therefore, in the present embodiment, a state acquisition unit is configured by the second battery sensor unit 82, second battery ECU 75 and the management ECU 71.

In step S25, the management ECU 71 determines whether the temperature Tbat2 of the second battery B2 is higher than the third temperature threshold T3 explained by referencing FIG. 5. As mentioned above, the management ECU 71 starts limiting discharging of the second battery B2 by decreasing the output opening rate R2out from 100% to 0% if the temperature Tbat2 of the second battery 82 exceeds the third temperature threshold T3, in order to suppress degradation of the second battery B2, and inhibits discharging of the second battery B2 by setting the output opening rate R2out as 0% if the temperature Tbat2 of the second battery B2 exceeds the fourth temperature threshold T4.

In the case of the determination result in Step S25 being NO, the management ECU 71 advances to Step S26. In Step S26, the management ECU 71 calculates the lower limit voltage Vlim corresponding to the lower limit for the closed circuit voltage of the first battery B1, and then advances to Step S28. Herein, case of the determination result in Step S25 being NO corresponds to a case of the temperature 7hat2 of the second battery B2 being no more than the third temperature threshold B3, i.e. case of not requiring to limit the discharge of the second battery B2. consequently, in Step S26, the management. ECU 71 calculates the degradation lower limit voltage for the closed circuit voltage of the first battery B1 based on information related to the internal state of the first battery B1 sent from the first battery ECU 74, and then sets this as the lower limit voltage Vlim.

Next, in Step S28, the management ECU 71 calculates the voltage limit output Pmax_v of the first battery B1, and then advances to Step S29. Herein, voltage limit output Pmax_v corresponds to a value arrived at by setting the upper limit for the output power of the first battery B1 based on the lower limit voltage Vlim. In other words, the management ECU 71 calculates the voltage limit voltage Pmax_v so that the closed circuit voltage of the first battery B1 becomes at least the lower limit voltage Vlim. Therefore, the management ECU 71 calculates the voltage limit output Pmax_v according to the following equation (1), based on the internal resistance R of the first battery B1, static voltage OCV of the first battery B1, and the lower limit voltage Vlim.

Pmax_v=)OCV−Vlim)/R×Vlim (1)

Next, in Step S29, the management ECU 71 calculates the current limit output Pmax_i of the first battery B1, and then advances to Step S30. Herein, current limit output Pmax__i corresponds to a value arrived at by setting the upper limit for the output power of the first battery B1 based on the maximum permitted current Imax. In other words, the management ECU 71 calculates the current limit output Pmax_i so that the electrical current flowing in the first battery B1 becomes no more than the maximum permitted current Imax. Therefore, the management ECU 71 calculates the current limit output Pmax_i according to the following equation (2), based on the internal resistance R, static voltage OCV of the first battery B1 and the maximum permitted current Imax.

Pmax_i=Imax×(OCV−Imax×R) (2)

Next, in Step S30, the management ECU 71 calculates the first output power upper limit Plout_max based on the voltage limit output Pmaxv and the current limit output Pmax_ir and then advances to Step S9 in FIG. 4. More specifically, the management ECU 71 sets, as the first output power upper limit Plout_max, the smaller one among the voltage limit output Pmax_v and the current limit output Pmax_i (one closer to 0), as shown in equation (3) below. By calculating the first output power upper limit Plout_max in this way, it is possible to set the output power of the first battery B1 to no more than the voltage limit output Pmax_v and current limit output Pmax_i, set the closed circuit voltage of the first battery B1 to at least the lower limit voltage VIim, and further set the electrical current flowing in the first battery B1 to no more than the maximum permitted currant Imax_i.

Plout_max=Min(Pmax__v, Pmax_i) (3)

In addition, in the case of the determination result in Step S25 being YES, the management ECU 71 advances to Step S27. In Step S27, the management ECU 71 calculates the lower limit voltage Vlim of the first battery B1, and then advances to Step S23. Herein, case of the determination result in Step S25 being YES, corresponds to a case of the temperature Tbat2 of the second battery B2 being higher than the third temperature threshold T3, i.e. case of requiring to limit the discharge of the second battery B2. However, as explained by referencing FIG. 3, since a freewheeling diode establishing from a side of the second power circuit 3 to a side of the first power circuit 2 as a forward direction is included in the voltage converter 5, if the voltage of the first power lines 21p, 21n, i.e. closed circuit voltage of the first battery B1, becomes lower than the voltage of the second power lines 31p, 3in, i.e. static voltage of the second battery B2, the second battery B2 turns to discharge, and positive passing current flows via the freewheeling diode. Therefore, in Step S27, the management ECU 71 calculates the static voltage of the second battery B2 based on information related to the internal state of the second battery B2 sent from the second battery ECU 75, and sets this as the lower limit voltage Vlim. The management. ECU 71, in the case of the temperature Tbat2 of the second battery B2 being higher than the third temperature threshold T3, can thereby calculate the first output power upper limit Plout_max so that the closed circuit voltage of the first battery B1 becomes at least the static voltage of the second battery B2.

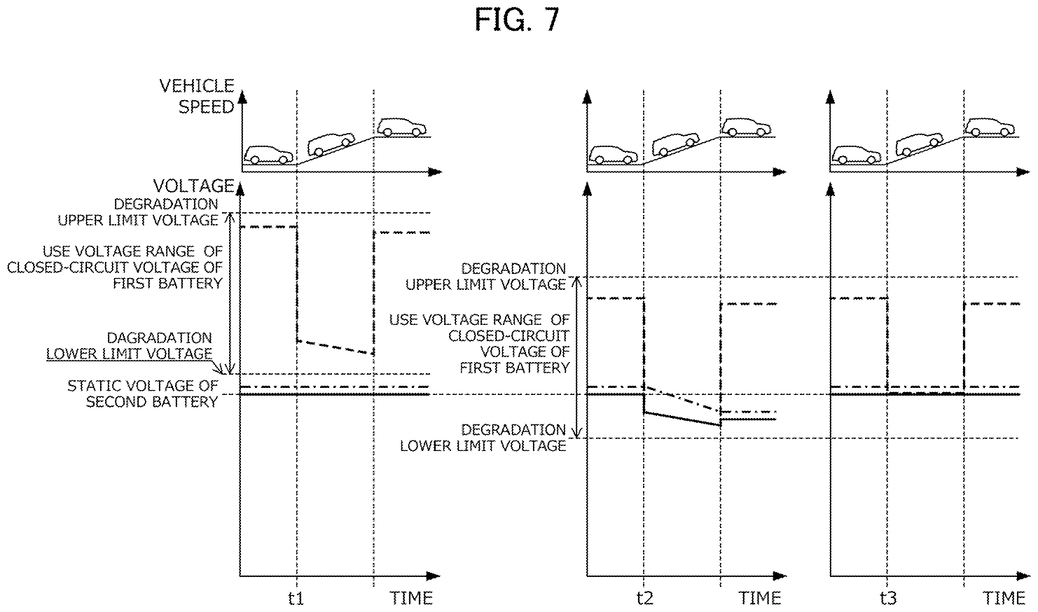

Next, the effects of the power supply system 1 according to the present embodiment will be explained while referencing FIG. 7. FIG. 7 provides time charts showing changes in voltage of the first battery B1 (bold broken line), voltage of second battery B2 (bold solid line), and charge rate of the second battery B2 (bold dashed line), when accelerating in a state in which the temperature of the second battery B2 is higher than the third temperature threshold. The left side in FIG. 7 shows a case of the static voltage of the second battery B2 being lower than the degradation lower limit voltage of the first battery B1, and the center and right side show cases of the static voltage of the second battery B2 being higher than the degradation lower limit voltage of the first battery B1. In addition, the right side in FIG. 7 shows a case of setting the first output power upper limit Plout_max in accordance with the flowchart of FIG. 6, and the center in FIG. 7 shows a comparative example establishing the lower limit voltage VIim of the first battery B1 as the degradation lower limit voltage of the first battery B1.

As shown on the left side in FIG. 7, when the requested drive power increases from 0 to a positive predetermined value by the driver stepping on the accelerator pedal at time t1, the closed circuit voltage of the first battery B1 declines by outputting power according to this request from the first battery B1. However, in the example on the left side in FIG. 7, since the degradation lower .limit voltage of the first battery B1 is higher than the static voltage of the second battery B2, the closed circuit voltage of the first battery B1 is always maintained higher than the static voltage of the second battery B2. consequently, as long as turning OFF the voltage converter 5, since the power will not be outputted from, the second battery B2, the voltage thereof is maintained at the static voltage, and the charge rate thereof is also maintained constant.

Next, as shown in the center of FIG. 7, since the lower limit voltage Vlim of the first battery B1 is always set as the degradation lower limit voltage in the comparative example, when the driver steps on the accelerator pedal at time t2, there are cases where the closed circuit voltage of the first battery B1 falls below the static voltage of the second battery B2. For this reason, in the comparative example, there are cases where the second battery 32 turns to discharge at time t2 and later, irrespective of being in a State desiring to Inhibit discharge of the second battery B2.

In contrast, as shown on the right side in FIG. 7, in the case of the temperature of the second battery B2 being higher than the third temperature threshold in the flowchart of FIG. 6, the static voltage of the second battery B2 which is higher than the degradation lower limit voltage of the first battery B1 is set as the lower limit voltage Vlim of the first battery B1. For this reason, even when the driver steps on the accelerator pedal at time t3, since the closed circuit voltage of the first battery B1 becomes lower than the static voltage of the second battery B2, so long as turning OFF the voltage converter 5, the second battery B2 will not turn to discharge.

FIG. 8 is a flowchart showing a specific sequence of power management processing during regeneration of the drive motor M. This power management processing (during regeneration) is repeatedly executed at a predetermined period in the management ECU 71 during regeneration of the drive motor M.

First, in Step S31, the management ECU 71 calculates the requested auxiliary power Paux of the vehicle auxiliary 42 in accordance with the same sequence as Step S1 in FIG. 4, and then advances to Step S32.

Next, in Step S32, the management ECU 71 calculates the requested regenerative power Pin_d corresponding to the request for power supplied to the first power circuit 2 from the drive motor M via the power converter 43 during regeneration of the drive motor M, and then advances to Step S33. The management ECU 71 calculates the requested regenerative brakirxg torque corresponding to the request for regenerative braking torque generated by the drive motor M based on the operation amount of. the pedals P such as the accelerator pedal and brake pedal (refer to FIG. 1) by the driver/and calculates the requested regeneration power Pin_d by converting this requested regenerative braking torque into power.

Next, in Step S33, the management ECU 71 calculates the total requested regeneration power Ptot_in corresponding to the request for the total sum o: regeneration power supplied to the first battery B1 and second battery B2, by subtracting the requested auxiliary power Paux calculated in Step S31 from the requested regeneration power Pin_d calculated in Step S32, and then advances to Step S34.

Next, in Step S34, the management ECU 71 calculates the basic value P2in_bs for the upper limit of the power inputted to the second battery B2 (i.e. second regeneration power upper limit P2in_max described later), and then advances to Step 335. More specifically, the management ECU 71 calculates the basic value P2in_bs, by searching a map (not shown) based on information related to parameters representing the internal state of the second battery B2 sent from the second battery ECU 75.

Next, in Step S35, the management ECU 71 calculates an input opening rate R2in for the upper limit of power inputted to the second battery B2 (i.e. second regeneration power upper limit P2in_max), and then advances to Step S36. More specifically, the management ECU 71 calculates the temperature Tbat2 of the second battery B2, based on information related to the internal state of the second battery B2 sent from the second battery ECU 75, and calculates the input opening rate R2in by searching an opening rate calculation map illustrated in FIG. 5, based on this temperature Tbat2.

As shown in FIG. 5, the management ECU 71, in the case of the temperature Tbat2 of the second battery B2 being no higher than the first temperature threshold T1 decided to be smaller than the third temperature threshold T3, sets the input opening rate R2in of the second battery B2 to 100%, and in the case of the temperature Tbat2 of the second battery B2 being higher than the second temperature threshold T2 set to be higher than the first temperature threshold T1 and lower than the third temperature threshold T3, sets the input opening rate R2 in of the second battery B2 to 0%. In other words, the management ECU 71, in the case of the temperature Tbat2 of the second battery B2 being higher than the second temperature threshold T2, sets the upper limit for power inputted to the second battery B2 as 0 in order to prevent degradation by the second battery B2 in a high temperature state charging, and thus inhibits charging of the second battery B2.

In addition, the management ECU 71, in the case of the temperature Tbat2 of the second battery B2 being higher than the first temperature threshold T1 and no more than the second temperature threshold T2, sets a smaller input opening rate R21n of the second battery B2 as the temperature Tbat2 rises. In other words, the management ECU 71, in the case of the temperature Tbat2 of the second battery B2 being higher than the first temperature threshold T1, makes the second regeneration power upper limit P2in_max described later approach 0 as the temperature Tbat2 rises. In other words, the management ECU 71, in the case of the temperature Tbat2 of the second battery B2 being higher than the first temperature threshold T1, executes the input limit control gradually limiting charging of the second battery B2 in order to prevent degradation by the second battery B2 in the high temperature state charging, by making the second regeneration power upper limit P2in_max approach 0 as the temperature Tbat2 rises. In addition, the management ECU 71, in the case of the temperature Tbat2 of the second battery B2 being higher than the second temperature threshold T2, executes input inhibition control for inhibiting charging of the second battery 52 by setting the second regeneration power upper limit P2in_max to 0.

Referring back to FIG. 8, in Step S36, the management ECU 71 calculates the second regeneration power upper limit P2in_max corresponding to the upper limit for power inputted to the second battery B2, and then advances to Step S37. More specifically, the management ECU 71 calculates the second regeneration power upper limit P2in_max, by multiplying the input opening rate R2in calculated in Step S35, by the basic value P2in_bs calculated in step S34.

In Step S37, the management ECU 71 calculates the target passing power Pcnv_cmd corresponding to the target for the passing power flowing from the side of the first power circuit 2 to the side of the second power circuit 3 in the voltage converter 5 during regeneration of the drive motor M (i.e. regeneration power supplied to the second battery B2), within a range establishing the second regeneration power upper limit P2in_max as the upper limit and 0 as the lower limit, and then advances to Step S38. More specifically, the management ECU 71 calculates the target passing power Pcnv_cmd so as not to exceed the second regeneration power upper limit P2in_max, based on information related to parameters representing the internal state of the first battery B1 sent from the first battery ECU 74, information related to parameters representing the internal state of the second battery B2 sent from the second battery ECU 75, requested regeneration power Pin__d, etc. The regeneration power supplied to the second battery B2 is thereby limited to the target passing power Pcnv_cmd decided within a range establishing the second regeneration power upper limit P2in_max as the upper limit, and 0 as the lower limit.

Next, in Step S38, the management ECU 71 calculates the first regeneration power upper limit Plin_max, which is the upper limit, for the regeneration power supplied to the first battery 31, and then advances to Step S39. More specifically, the management ECU 71 calculates the first regeneration power upper limit Plin__max, based on information related to parameters representing the internal state of the first battery B1 sent from the first battery ECU 74, information related to parameters representing the internal state of the second battery B2 sent from the second battery ECU 75, requested regeneration power Pin_d, etc.

It should be noted that, in Step S38, the management ECU 71 calculates the charge rate of the first battery B1, based on information related to parameters representing the internal state of the first battery B1 sent from the first battery ECU 74, and in the case of this charge rate being higher than a predetermined charge rate upper limit, inhibits charging of the first battery B1 by establishing the first regeneration power upper limit Plin_max as 0. Overcharging of the first battery B1 is thereby prevented. In addition, in the case of the charge rate of the first battery B1 being no more than the charge rate upper limit, the management ECU 71 permits charging of the first battery B1 by establishing the first regeneration power upper limit Plin_max as a value greater than 0.

Next, in Step S39, the management ECU 71 determines whether the electric power obtained by subtracting the target passing power Pcnv_cmd from the total requested regeneration power Ptot_in is no more than the first regeneration power upper limit Plin_max. Herein, electric power obtained by subtracting the target passing power Pcnv_cmd from the total requested regeneration power Ptot_in corresponds to the request for regeneration power supplied to the first battery B1. Therefore, the determination in Step S39 corresponds to determining whether it is possible to satisfy the request from the driver without the regeneration power to the first battery B1 exceeding the first regeneration power upper limit Plin_max. The management ECU 71 advances to Step S40 in the case of the determination result in Step S39 being YES, and advances to Step $41 in the case of being NO.

In Step S40, the management ECU 71 calculates the target regeneration power Pin_cmd corresponding to the target for power supplied from the drive motor M to the first power circuit 2 via the power converter 43, and then advances to Step $42. In the case of the determination result in Step S39 being YES, since the regeneration power of the first battery B1 can satisfy the request of the driver without exceeding the first regeneration power upper limit Plin_max, the management ECU 71 establishes the requested regeneration power Pin_d calculated in Step S32 as the target regeneration power Pin_cmd.

In Step S43, the management ECU 71 calculates the target regeneration power Pin_cmd, and then advances to Step SA2. In the case of the determination result in Step S39 being NO, if trying to satisfy the request of the driver as mentioned above, since the regeneration power of the first battery B1 will exceed the first regeneration power upper limit Plin_max, the management ECU 71 calculates the target regeneration power Pin_cmd so that the regeneration power of the first battery B1 will not exceed the first regeneration power upper limit Plin_max. More specifically, the management ECU 71, for example, calculates the target regeneration power Pin_cmd by summing the first generation power upper limit PIin_max, target passing power Pcnv_cmd and requested auxiliary power Paux. The regeneration power to the first battery B1 thereby becomes the first regeneration power upper limit Plin_max, and will not exceed this first regeneration power upper limit Plin_max.

Next, in Step S42, the management ECU 71 generates a passing power command signal according to the target passing power Pcnv_crnd calculated in Step S37, sends this to the converter ECU 73, and then advances to Step S43. The converter ECU 73 operates the voltage converter 5 based on this passing power command signal. The regeneration power according to the target passing power Pcnv_cmd is thereby supplied from the first power circuit 2 to the second battery B2.

Next, in Step S43, the management ECU 71 generates a torque command signal based on the target regeneration power Pin_cmd, sends this to the motor ECU 72, and then ends the power management processing (during regeneration). More specifically, the management ECU 71 calculates the target regenerative braking torque by converting the target regeneration power Pin_cmd, and generates the torque command signal according to this target, regenerative braking torque. The motor ECU 72 operates the power converter 43 based on this torque command signal. The regeneration power according to the target regeneration power Pin_cmd is thereby supplied from the drive motor M to the first power circuit 2. In this way, with the management ECU 71, by generating the torque command signal based on the target regeneration power Pin_cmd calculated through the processing of Step S40 or S41, the regeneration power supplied to the first battery B1 will not exceed the first regeneration power upper limit Plin_max.

As described above, in the case of the charge rate of the first battery 31 being no more than a predetermined charge rate upper limit, the management ECU 71 permits charging of the first battery B1 by setting the first regeneration power-upper limit Plin_max as a value greater than 0 (refer to Step S38). Therefore, the management ECU 71, in the case of the requested regeneration power Pin_d exceeding the second regeneration power upper limit P2in_max and the charge rate of the first battery B1 being no more than the charge rate upper limit, during execution of input limitation control of limiting regeneration power to the second battery B2 or during execution of the Input inhibition control of inhibiting charging of the second battery B2, supplies at least part of the amount of the requested regeneration power Pin_d which could not be recovered by the second battery B2, to the first battery B1 within a range establishing the first generation power upper limit Plin_max as the upper limit and 0 as the lower limit.

In addition, as mentioned above, in the case of the charge rate of the first battery 31 being greater than the charge rate upper limit, the management ECU 71 inhibits charging of the first battery 31 by establishing the first regeneration power upper limit Plin_max as 0 (refer to Step S38) . Therefore, in the case of being during execution of input limitation control of limiting the regeneration power to the second battery B2 or during execution of input inhibition control of inhibiting charging of the second battery B2 and the charge rate of the first battery B1 being greater than the charge rate upper limit (case oi Plin_max=0), the management ECU 71 controls the target regeneration power Pin_cmd to no more than the total regeneration power upper limit decided by summing the target passing power Pcnv_cmd and the requested auxiliary power Paux (refer to Step S41) . In addition, the upper limit of the target passing power Pcnv_crad equals the second regeneration power upper limit P2in_max calculated so as to become smaller as the temperature Tbat2 of the second battery B2 rises (refer to Steps S36 and S37) . in other words, the management. ECU 71, in the case of being during execution of the input limitation control to the second battery 32 and inhibiting charging of the first battery B1, makes the above-mentioned total regeneration power upper limit approach 0 as the temperature Tbat2 of the second battery 32 rises,

According to the power supply system 1 related to the above such present embodiment, the following effects are exerted.

(1) The power supply system 1 connects the first power circuit 2 having the first battery B1 and the second power circuit 3 having the second battery B2 which has a use voltage range relative to the closed circuit voltage that overlaps the first battery B1 and a static voltage that is lower than the first battery B1, by the voltage converter 5, and connects the second power circuit 3 and the drive motor M by the power converter 43. The management ECU 71, motor ECU 72 and converter ECU 73 control the transfer of power between the first and second batteries B1, 82 and the drive motor M, by operating the voltage converter 5 and power converter. 43. When the use voltage ranges overlap between the first battery B1 and second battery B2, the requested drive power Pout_d of the drive motor M becomes greater, and when the electrical current flowing in the first battery B1 increases, there are cases where the closed circuit voltage of the first battery B1 becomes lower than the static voltage of the second battery B2. When the closed circuit voltage of the first battery B1 becomes lower than the static voltage of the second battery B2 in this way, there are cases where power is outputted unintentionally from the second battery 82. In contrast, the power supply system 1, in the case of the temperature Tbat2 of the second battery B2 being higher than the first temperature threshold T1, executes input limitation control of controlling the regeneration power supplied to the second battery B2 to within a range establishing the second regeneration power upper limit P2in_max as the upper limit and 0 as the lower limit, and makes the second regeneration power upper limit P2in_max approach 0 as the temperature Tbat2 of the second battery B2 rises. In other words, according to the power supply system 1, by limiting the regeneration power to the second battery B2 at a stage where the temperature Tbat2 of the second battery B2 exceeds the first temperature threshold T1 decided to be lower than the fourth temperature threshold T4 at which inhibiting charging and discharging of the second battery B2, while the second battery B2 subsequently becomes even higher temperature, it is possible to gradually bring down the charge rate and static voltage of the second battery B2 and widen the voltage difference between the first battery B1 and second battery B2. Consequently, according to the power supply system 1, it is possible to suppress degradation by unintended discharge of the second battery B2 in the high temperature state. In addition/ according to the power supply system 1, by limiting charging to the second battery B2 at a stage where the temperature Tbat2 of the second battery B2 exceeded the first, temperature threshold T1, it is possible to suppress degradation of the second battery B2 from charging being performed in the high temperature state. In addition/according to the power supply system 1, by making the second regeneration power upper limit P2in_max approach 0 as the temperature Tbat2 of the second battery B2 rises, it is possible to lower the charge rate of the second battery 132 without giving an uncomfortable feeling to the driver.

(2) The management SOU 71, motor ECU 72 and converter ECU 73 supply regeneration power to the first battery B1, in the case of the requested regeneration power Pin_d relative to the drive motor M exceeding the second regeneration power upper limit P2in_max and the charge rate of the first battery B1 being less than the charge rate upper limit during execution of the input limitation control. Consequently, according to the power supply system 1, since it is possible to supply to the first battery 31 the regeneration power which could not be supplied to the second battery 82, it is possible to suppress degradation of the second battery B2 without wasting the regeneration power.

(3) The management ECU 71, motor ECU 72 and converter ECU 73, in the case of being during execution of the input limitation control and the charge rate of the first battery B1 being greater than the charge rate upper limit, control the regeneration power supplied from the drive motor M to the first power circuit 2 to within a range establishing the total regeneration power upper limit (Pcnv_cmd×Paux) as the upper limit and 0 as the lower limit, and make the total regeneration power upper limit approach 0 as the temperature Tbat2 of the second battery B2 rises, consequently, according to the power supply system 1, since it is possible to prevent the first battery B1 from reaching overcharge while limiting the regeneration power to the second battery B2, it is possible to suppress degradation of both the first battery B1 and second battery B2. In addition, with the power supply system 1, by making the total regeneration power upper limit approach 0 as the temperature Tbat2 of the second battery B2 rises, it is possible to prevent the regenerative braking from suddenly decreasing.

(4) The management ECU 71, motor ECU 72 and converter ECU 73, in the case of the temperature Tbat2 of the second battery B2 being higher than the third temperature threshold T3 decided to be higher than the first temperature threshold T1, control the output power of the second battery B2 to within a range establishing the second output power upper limit P2out_max as the upper limit and 0 as the lower limit and make the second output power upper limit P2out_max approach 0 as the temperature Tbat2 of the second battery B2 rises. In other words, with the power supply system 1, by deciding the third temperature threshold T3 at which starting limitation of the output power of the second battery B2 to be higher than the first temperature threshold T1 at which starting limitation of regeneration power to the second battery B2, while the temperature Tbat2 of the second battery B2 is between the first temperature threshold T1 and third temperature threshold T3, since it is possible to permit discharge of the second battery B2 while limiting the regeneration power to the second battery B2, it is possible to further widen the voltage difference between the first battery B1 and second battery B2 after the temperature Tbat2 of the second battery B2 has exceeded the first temperature threshold T1. Consequently, according to the power supply system 1, it is possible to further suppress degradation by unintended discharge of the second battery B2 in a high temperature state. In addition, according to the power supply system 1, by making the second output power upper limit P2out_max approach 0 as the temperature Tbat2 of the second battery B2 rises, it is possible to cause the charge rate of the second battery B2 to decline without giving an uncomfortable feeling to the driver.

(5) The management ECU 71, motor ECU 72 and converter ECU 73, in the case of the temperature Tbat2 of the second battery B2 being higher than the third temperature threshold T3, control the output power of the first battery B1 to within a range establishing the first output, power upper limit Plout_max as the upper limit and 0 as the lower limit, and set the first output power upper limit Plout_max so that the closed circuit voltage of the first battery B1 becomes at least the static voltage of the second battery B2. Consequently, according to the power supply system 1, even in a case of the static voltage of the second battery 82 not sufficiently declining even when executing the input limitation control, since it is possible to limit the output power of the first battery B1 so that the closed circuit voltage of the first battery B1 will not fall below the static voltage of the second battery B2, it is possible to more reliably suppress unintended discharge from the second battery B2, and thus possible to suppress degradation of the second battery B2.

(6) The management ECU 71, motor ECU 72 and converter ECU 73, in the case of the temperature Tbat2 of the second battery B2 being higher than the fourth temperature threshold T4 decided to be higher than the first temperature threshold T1, inhibit charge and discharge of the second battery B2. Consequently, with the power supply system 1, by limiting the regeneration power to the second battery B2 at a stage where the temperature Tbat2 of the second battery B2 exceeded the first temperature threshold T1 which is decided to be lower than the fourth temperature threshold T4 at which inhibiting charge and discharge of the second battery B2, while the temperature Tbat2 of the second battery B2 subsequently reaches the fourth temperature threshold T4, since it is possible to lower the charge rate and static voltage of the second battery B2, it is possible to secure sufficient voltage difference between the first battery b1 and the second battery b2, at the moment when the temperature That2 of the second battery B2 reached the fourth temperature threshold T4. Consequently, according to the power supply system 1, it is possible to more reliably suppress unintended discharge from the second battery B2 in a state in which the temperature Tbat2 of the second battery B2 is higher than the fourth temperature threshold T4.

Although an embodiment of the present invention has been explained above, the present invention is not limited thereto. The configurations of detailed parts may be modified as appropriate within the scope of the gist of the present invention.

What is claimed is:

1. A power supply system comprising:
a high-voltage circuit having a first electrical storage device;
a low-voltage circuit having a second electrical storage device having a use voltage range relative to closed circuit voltage which overlaps the first electrical storage device, and a static voltage which is lower than the first electrical storage device;
a voltage converter which converts voltage between the high-voltage circuit and the low-voltage circuit;
a power converter which converts power between a rotary electrical machine coupled with a drive wheel, and the high-voltage circuit;
a second electrical storage device temperature acquisition unit for acquiring a second electrical storage device temperature, which is a temperature of the second electrical storage device; and
a control device which controls transfer of power between the first electrical storage device and the second electrical storage device and the rotary electrical machine, by operating the voltage converter and the power converter,
wherein the control device, in a case of the second electrical storage device temperature being higher than a first temperature threshold, executes input limitation control of controlling a regeneration power supplied to the second electrical storage device to within a range establishing a second regeneration power upper limit as an upper limit, and makes the second regeneration power upper limit approach 0 as the second electrical storage device temperature rises.

2. The power supply system according to claim 1, further comprising a first remaining amount parameter acquisition unit for acquiring a first remaining amount parameter which increases in response to a remaining amount of the first electrical storage device,
wherein the control device supplies regeneration power to the first electrical storage device, in a case of a requested regeneration power relative to the rotary electrical machine exceeding the second regeneration power upper limit and the first remaining amount parameter being less than a first remaining amount threshold, during execution of the input limitation control.

3. The power supply system according to claim 2, wherein the control device, in a case of being during execution of the input limitation control and the first remaining amount parameter being greater than the first remaining amount threshold, controls regeneration power supplied from the rotary electrical machine to the high-voltage circuit to within a range establishing a total regeneration power upper limit as the upper limit, and makes the total regeneration power upper limit approach 0 as the second electrical storage device temperature rises.

4. The power supply system according to claim 1, wherein the control device/ in a case of the second electrical storage device temperature being higher than a third temperature threshold decided to be higher than the first temperature threshold, controls output power of the second electrical storage device to within a range establishing a second output power upper limit as an upper limit, and makes the second output power upper limit approach 0 as the second electrical storage device temperature rises.

5. The power supply system according to claim 2, wherein the control device, in a case of the second electrical storage device temperature being higher than a third temperature threshold decided to be higher than the first temperature threshold, controls output power of the second electrical storage device to within a range establishing a second output power upper limit as an upper limit, and makes the second output power upper limit approach 0 as the second electrical storage device temperature rises.

6. The power supply system according to claim 3, wherein the control device, in a case of the second electrical storage device temperature being higher than a third temperature threshold decided to be higher than the first temperature threshold, controls output power of the second electrical storage device to within a range establishing a second output power upper limit as an upper limit, and makes the second output, power upper limit approach 0 as the second electrical storage device temperature rises.

7. The power supply system according to claim 4, wherein the control device/in a case of the second electrical storage device temperature being higher than the third temperature threshold, controls output power of the first electrical storage device to within a range establishing a first output power upper limit as an upper limit, and sets the first output power upper limit so that a closed circuit voltage of the first electrical storage device becomes at least a static voltage of the second electrical storage device.

8. The power supply system according to claim 5, wherein the control device, in a case of the second electrical storage device temperature being higher than the third temperature threshold, controls output power of the first electrical storage device to within a range establishing a first output power upper limit as an upper limit, and sets the first output power upper limit so that a closed circuit voltage of the first electrical storage device becomes at least a static voltage of the second electrical storage device.

9. The power, supply system according to claim 6, wherein the control device, in a case of the second electrical storage device temperature being higher than the third temperature threshold, controls output power of the first electrical storage device to within a range establishing a first output power upper limit as an upper limit, and sets the first output power upper limit so that a closed circuit voltage of the first electrical storage device becomes at least a static voltage of the second electrical storage device.

10. The power supply system according to claim 1, wherein the control device inhibits charge and discharge of the second electrical storage device, in a case of the second electrical storage device temperature being higher than a fourth temperature threshold which is decided to be higher than the first temperature threshold.

11. The power supply system according to claim 2, wherein the control device inhibits charge and discharge of the second electrical storage device, in a case of the second electrical storage device temperature being higher than a fourth temperature threshold which is decided to be higher than the first temperature threshold.

12. The power supply system according to claim 3, wherein the control device inhibits charge and discharge of the second electrical storage device, in a case of the second electrical storage device temperature being higher than a fourth temperature threshold which is decided to be higher than the first temperature threshold.

13. The power supply system according to claim 4, wherein the control device inhibits charge and discharge of the second electrical storage device, in a case of the second electrical storage device temperature being higher than a fourth temperature threshold which is decided to be higher than the first temperature threshold.

14. The power supply system, according to claim 5, wherein the control device inhibits charge and discharge of the second electrical storage device, in a case of the second electrical storage device temperature being higher than a fourth temperature threshold which is decided to be higher than the first temperature threshold.

15. The power supply system according to claim 6, wherein the control device inhibits charge and discharge of the second electrical storage device, in a case of the second electrical storage device temperature being higher than a fourth temperature threshold which is decided to be higher than the first temperature threshold.

16. The power supply system according to claim 1, wherein the control device inhibits charge and discharge of the second electrical storage device, in a case of the second electrical storage device temperature being higher than a fourth temperature threshold which is decided to be higher than the first temperature threshold.

17. The power supply system according to claim 8, wherein the control device inhibits charge and discharge of the second electrical storage device, in a case of the second electrical storage device temperature being higher than a fourth temperature threshold which is decided to be higher than the first temperature threshold.

18. The power supply system according to claim 9, wherein the control device inhibits charge and discharge of the second electrical storage device, in a case of the second electrical storage device temperature being higher than a fourth temperature threshold which is decided to be higher than the first temperature threshold.
